(19) United States
(12) Patent Application Publication
(10) Pub. No.: US 2026/0128673 A1
(43) Pub. Date: May 7, 2026

(54) SWITCHED-CAPACITOR VOLTAGE CONVERTER, CHIP, AND ELECTRONIC DEVICE

(71) Applicant: Zhuhai Nanxin Semiconductor Technology Co., Ltd., Zhuhai (CN)

(72) Inventors: Hongyang XIE, Zhuhai (CN); Liuniu GUO, Zhuhai (CN)

(73) Assignee: Zhuhai Nanxin Semiconductor Technology Co., Ltd., Zhuhai (CN)

(21) Appl. No.: 19/380,999

(22) Filed: Nov. 6, 2025

(30) Foreign Application Priority Data
Nov. 6, 2024 (CN) 202411582876.1

(51) Int. Cl. H02M 3/07

(52) U.S. Cl. CPC H02M 3/07

(57) ABSTRACT

Provided are a switched-capacitor voltage converter, a chip, and an electronic device. The switched-capacitor voltage converter performs a buck or boost operation on the input voltage based on the different charging and discharging states of the capacitors and the different states of the first and second branches in different stages. The current of the transistors in the switched-capacitor voltage converter may be instantaneously zero, thereby significantly reducing the switching loss of the transistors. Moreover, the capacitors are not subject to conduction loss, such that the power loss of the switched-capacitor voltage converter is further reduced.

### CROSS REFERENCE TO THE RELATED APPLICATIONS

This application is based upon and claims priority to Chinese Patent Application No. 202411582876.1. filed on November 6, 2024, the entire contents of which are incorporated herein by reference.

### TECHNICAL FIELD

The present disclosure relates to the technical field of power management chips, and in particular, relates to a switched-capacitor voltage converter, a chip, and an electronic device.

### BACKGROUND

In the related art, a voltage converter of a switching power supply is typically used to convert an input voltage into an output voltage that is the same as or different from the input voltage in terms of magnitude. In such a voltage converter of a switching power supply, the input voltage is boosted or bucked based on energy storage of an inductor and adjustment of a duty cycle of transistors within a switched-capacitor voltage converter. However, due to a large equivalent resistance of the inductor and a freewheeling current generated by the inductor at an instant the switched-capacitor voltage converter is switched on or off, the voltage converter of the switching power supply suffers from significant power loss. Consequently, the efficiency of the voltage converter of the switching power supply is limited, and thus the voltage converter of the switching power supply is unsuitable for high-load applications.

For example, batteries with a low shutdown voltage are widely used in production and daily life due to their excellent performance. However, the low shutdown voltage of such batteries fails to meet full-power output requirements of most electronic components in electronic devices. Therefore, it is necessary to perform voltage conversion on the voltage output by the battery with a low shutdown voltage using a voltage converter of a switching power supply. The voltage converted by the voltage converter of the switching power supply is then supplied to the electronic device to power the electronic components thereof.

In a case where a voltage converter of a switching power supply is employed to boost the voltage output from a battery with a low shutdown voltage, the power loss in the voltage converter of the switching power supply is substantial due to the characteristics of the inductor. At the instant the transistors in the voltage converter of the switching power supply are turned on or off, the inductor generates a freewheeling current in the circuit, thereby inducing high switching loss. Moreover, the inductor in the voltage converter of the switching power supply has a large equivalent series resistance. This leads to conduction thermal loss when the inductor is operating, and consequently the boost efficiency of the voltage converter of the switching power supply is limited. This prevents the voltage converter of the switching power supply from supplying power to electronic devices with high loads.

Furthermore, as the shutdown voltage of a battery with a low shutdown voltage decreases further, the duty cycle of the transistors in the voltage converter of the switching power supply needs to be reduced. In a case where the duty cycle of the transistors in the voltage converter of the switching power supply is reduced, the peak current of the inductor increases accordingly, resulting in higher losses during voltage transmission. Additionally, a reduction in the duty cycle of the transistors in the voltage converter of the switching power supply also necessitates the use of a larger-sized inductor in the voltage converter of the switching power supply, which further increases the loss during the voltage transmission process.

### SUMMARY

The present disclosure provides a switched-capacitor voltage converter, a chip, and an electronic device, to solve the technical problem that the inductor in the switched-capacitor voltage converter induces high loss.

In a first aspect, some embodiments of the present disclosure provide a switched-capacitor voltage converter. The switched-capacitor voltage converter includes: a controller, a first transistor, and at least one conversion assembly.

A first terminal of the first transistor is electrically connected to the at least one conversion assembly, a second terminal of the first transistor is grounded, and a control terminal of the first transistor is electrically connected to the controller.

The switched-capacitor voltage converter includes a first terminal and a second terminal, wherein the at least one conversion assembly is electrically connected between the first terminal and the second terminal of the switched-capacitor voltage converter, each of the at least one conversion assembly includes a capacitor and a plurality of transistors, and the at least one conversion assembly includes a first branch and a second branch, wherein the first branch and the second branch share the capacitor.

In a case where the switched-capacitor voltage converter operates in a boost mode: in a first stage, the first branch is in a charging state, the at least one conversion assembly is cascaded and is grounded via the first transistor, the second branch is in a disconnected state, an input voltage is present at the first terminal of the switched-capacitor voltage converter, and no output voltage is present at the second terminal of the switched-capacitor voltage converter; and in a second stage, the first branch is in a disconnected state, the second branch is in a discharging state, an input voltage is present at the first terminal of the switched-capacitor voltage converter, and an output voltage is present at the second terminal of the switched-capacitor voltage converter.

In a case where the switched-capacitor voltage converter operates in a buck mode: in a third stage, the second branch is in the charging state, the first branch is in a disconnected state, an input voltage is present at the second terminal of the switched-capacitor voltage converter, and an output voltage is present at the first terminal of the switched-capacitor voltage converter; and in a fourth stage, the first branch is in the discharging state, the at least one conversion assembly is cascaded and is grounded via the first transistor, the second branch is in a disconnected state, no input voltage is present at the second terminal of the switched-capacitor voltage converter, and an output voltage is present at the first terminal of the switched-capacitor voltage converter.

The switched-capacitor voltage converter according to the present disclosure performs a buck or boost operation on the input voltage based on the different charging and discharging states of the capacitors and the different states of the first and second branches in different stages. Therefore, the switched-capacitor voltage converter according to the present disclosure allows the instantaneous current to be zero, such that the switched-capacitor voltage converter achieves soft switching, and thus the switching loss is significantly reduced. Moreover, the capacitors according to the present disclosure are not subject to conduction loss, such that the power loss of the switched-capacitor voltage converter is further reduced. In addition, capacitors per unit volume support a large peak current, such that the power density of the switched-capacitor voltage converter is effectively increased.

In some embodiments, each of the at least one conversion assembly includes: a second transistor, a third transistor, a fourth transistor, and the capacitor.

A first terminal of the third transistor is electrically connected to the second terminal of the switched-capacitor voltage converter, a second terminal of the third transistor is electrically connected to a first terminal of the capacitor, and a control terminal of the third transistor is electrically connected to the controller.

A first terminal of the fourth transistor is electrically connected to the first terminal of the switched-capacitor voltage converter, a second terminal of the fourth transistor is electrically connected to a second terminal of the capacitor, and a control terminal of the fourth transistor is electrically connected to the controller.

A first terminal of the second transistor is electrically connected between the second terminal of the third transistor and the first terminal of the capacitor, a second terminal of the second transistor is electrically connected to the first terminal of the switched-capacitor voltage converter or is electrically connected to an adjacent one of the at least one conversion assembly, and a control terminal of the second transistor is electrically connected to the controller.

In some embodiments, in the first stage, the first transistor and the second transistor are turned on, the third transistor and the fourth transistor are turned off, and the capacitor is in the charging state; and in the second stage, the first transistor and the second transistor are turned off, the third transistor and the fourth transistor are turned on, and the capacitor is in the discharging state; and in the third stage, the first transistor and the second transistor are turned off, the third transistor and the fourth transistor are turned on, and the capacitor is in the charging state; and in the fourth stage, the first transistor and the second transistor are turned on, the third transistor and the fourth transistor are turned off, and the capacitor is in the discharging state.

In some embodiments, in a case where a number of the at least one conversion assembly is one: in the one conversion assembly, the second terminal of the second transistor is electrically connected to the first terminal of the switched-capacitor voltage converter; and the first terminal of the first transistor is electrically connected between the second terminal of the capacitor and the second terminal of the fourth transistor in the one conversion assembly.

In some embodiments, in a case where a number of the at least one conversion assembly is greater than one, the plurality of conversion assemblies are connected in series.

A second terminal of the second transistor in a first one of the plurality of conversion assemblies is electrically connected to the first terminal of the switched-capacitor voltage converter, and a second terminal of the second transistor in each of remaining ones of the plurality of conversion assemblies is electrically connected to a first terminal of the capacitor in an adjacent conversion assembly.

A second terminal of the capacitor in a last one of the plurality of conversion assemblies is electrically connected to the first terminal of the first transistor.

In some embodiments, in a case where the switched-capacitor voltage converter operates in the boost mode and a number of the at least one conversion assembly is N, wherein N is a positive integer, a ratio of a magnitude of an input voltage of the switched-capacitor voltage converter to a magnitude of an output voltage of the switched-capacitor voltage converter is N:(N+1); or in a case where the switched-capacitor voltage converter operates in the buck mode and a number of the at least one conversion assembly is N, wherein N is a positive integer, a ratio between a magnitude of an input voltage of the switched-capacitor voltage converter and a magnitude of an output voltage of the switched-capacitor voltage converter is (N+1):N.

In some embodiments, the switched-capacitor voltage converter further includes: a fifth transistor.

A first terminal of the fifth transistor is electrically connected to the first terminal or the second terminal of the switched-capacitor voltage converter, a second terminal of the fifth transistor is electrically connected to a load, and a control terminal of the fifth transistor is electrically connected to the controller.

The switched-capacitor voltage converter is configured to supply a voltage to the load in a case where the fifth transistor is turned on.

Alternatively, the switched-capacitor voltage converter is configured to not supply a voltage to the load in a case where the fifth transistor is turned off.

In some embodiments, the switch includes: a sixth transistor.

A first terminal of the sixth transistor is electrically connected to the first terminal of the switched-capacitor voltage converter, a second terminal of the sixth transistor is electrically connected to the load, and a control terminal of the sixth transistor is electrically connected to the controller.

In response to a first instruction from the controller, the fifth transistor is turned off, the sixth transistor is turned on, and the switched-capacitor voltage converter does not supply the voltage to the load.

Alternatively, in response to a second instruction from the controller, the fifth transistor is turned on, the sixth transistor is turned off, and the switched-capacitor voltage converter supplies the voltage to the load.

In a second aspect, some embodiments of the present disclosure provide a chip. The chip includes the switched-capacitor voltage converter as described above.

In a third aspect, some embodiments of the present disclosure provide an electronic device. The electronic device includes the chip as described above.

For details about the beneficial effects achieved by the method according to the second and third aspects and the embodiments of the second and third aspects, reference may be made to the beneficial effects achieved by the first aspect or any embodiment of the first aspect, which are not described herein any further.

### BRIEF DESCRIPTION OF THE DRAWINGS

FIG. 1 is a circuit diagram of a voltage converter of a switching power supply

FIG. 2 is a schematic structural diagram of a switched-capacitor voltage converter electrically connected to a load according to some embodiments of the present disclosure.

FIG. 3 is a circuit diagram of a conversion assembly in a switched-capacitor voltage converter according to some embodiments of the present disclosure.

FIG. 4 is a circuit diagram of a switched-capacitor voltage converter where the number of conversion assemblies is one according to some embodiments of the present disclosure.

FIG. 5 is a circuit diagram of a switched-capacitor voltage converter where the number of conversion assemblies is more than one according to some embodiments of the present disclosure.

FIG. 6 is a circuit diagram of a switched-capacitor voltage converter where the number of conversion assemblies is two according to some embodiments of the present disclosure.

FIG. 7 is a circuit diagram of the switched-capacitor voltage converter illustrated in FIG. 6 operating in a first stage.

FIG. 8 is a circuit diagram of the switched-capacitor voltage converter illustrated in FIG. 6 operating in a second stage.

FIG. 9 is a schematic structural diagram of another switched-capacitor voltage converter electrically connected to a load according to some embodiments of the present disclosure.

FIG. 10 is a schematic structural diagram of yet another switched-capacitor voltage converter electrically connected to a load according to some embodiments of the present disclosure.

### DETAILED DESCRIPTION OF THE EMBODIMENTS

In the present disclosure, the term "at least one" refers to one or more than one, and the term "a plurality of" refers to two or more than two. The term "and/or" is merely an association relationship for describing associated objects, which represents that there may exist three types of relationships. For example, the phrase "A and/or B" means (A), (B), or (A and B), wherein A and B may be single or plural. In addition, the symbol "/" generally represents an "or" relationship between associated objects before and after the symbol. The expression "at least one of the following" or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms "first," "second," and the like are merely for the illustration purpose, and shall not be construed as indicating or implying a relative importance.

In the description of the present disclosure, it should be understood that the terms "central," "transversal," "longitudinal," "upper," "lower," "left," "right," "front," "rear," and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms "connected," "coupled," and derivatives forms thereof shall be understood in a broad sense. For example, the terms "connected," "coupled," and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

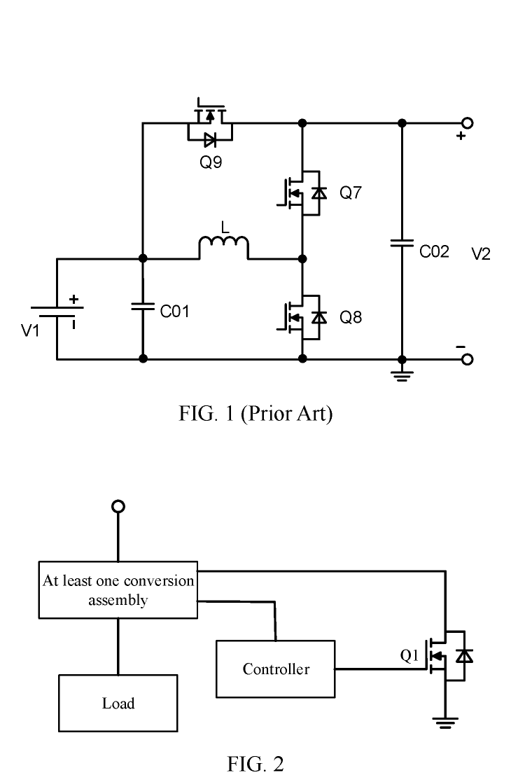

FIG. 1 is a circuit diagram of a voltage converter of a switching power supply. The voltage converter of the switching power supply illustrated in FIG. 1 includes: a seventh transistor Q7, an eighth transistor Q8, a ninth transistor Q9, an inductor L, a first capacitor C01, and a second capacitor C02.

A source of the seventh transistor Q7 is electrically connected to a drain of the eighth transistor Q8, and a source of the eighth transistor Q8 is grounded. A source of the ninth transistor Q9 is electrically connected to a battery, and a drain of the ninth transistor Q9 is electrically connected to a first output terminal of the voltage converter. A first terminal of the second capacitor C02 is electrically connected between the drain of the ninth transistor Q9 and the first output terminal of the voltage converter. A drain of the seventh transistor Q7 is electrically connected between the drain of the ninth transistor Q9 and the first terminal of the second capacitor C02.

A second terminal of the second capacitor C02 is grounded. The first capacitor C01 is connected in parallel to the battery. A first terminal of the inductor L is electrically connected to a positive terminal of the battery, and a second terminal of the inductor L is electrically connected between the source of the seventh transistor Q7 and the drain of the eighth transistor Q8. A gate of the seventh transistor Q7, a gate of the eighth transistor Q8, and a gate of the ninth transistor Q9 are all electrically connected to a control circuit in the voltage converter. The first output terminal of the voltage converter is electrically connected to an electronic device.

In a case where a magnitude of an output voltage V1 of the battery is less than that of a system voltage V2 required by the electronic device, the voltage converter formed by the seventh transistor Q7, the eighth transistor Q8, and the inductor L is used to boost the output voltage V1 of the battery to be greater than or equal to the system voltage V2 of the electronic device. In this case the ninth transistor Q9 is in a turned-off state. In the process where the voltage converter of the switching power supply boosts the output voltage V1 of the battery to be greater than or equal to the system voltage V2 of the electronic device, the seventh transistor Q7 and the eighth transistor Q8 are alternately turned on, and by adjusting the on-time of the seventh transistor Q7, i.e., a duty cycle of the seventh transistor Q7, a magnitude of a voltage output from the first output terminal of the voltage converter may be adjusted.

In a case where the magnitude of the output voltage V1 of the battery is less than that of the system voltage V2 required by the electronic device, the ninth transistor Q9 is in a turned-on state. In this case, the seventh transistor Q7, the eighth transistor Q8, and the inductor L are all inactive. That is, no boosting or bucking is performed on the output voltage V1 of the battery.

In performing voltage conversion based on the voltage converter of the switching power supply illustrated in FIG. 1, due to a large equivalent resistance of the inductor and a freewheeling current generated by the inductor at an instant the voltage converter of the switching power supply is switched on or off, the voltage converter of the switching power supply suffers from significant power loss.

In view of the above problems, embodiments of the present disclosure propose a switched-capacitor voltage converter, a chip, and an electronic device. In the switched-capacitor voltage converter, performing voltage conversion based on charging and discharging of capacitors replaces the scheme of performing voltage conversion based on an inductor in the switching supply voltage converter. Due to the absence of magnetic storage elements, such as inductors, the switched-capacitor voltage converter allows the instantaneous current to be zero. This reduces the power loss of the switched-capacitor voltage converter. Additionally, capacitors do not introduce conduction loss, such that the switched-capacitor voltage converter achieves higher conversion efficiency.

FIG. 2 is a schematic structural diagram of a switched-capacitor voltage converter electrically connected to a load according to some embodiments of the present disclosure. As illustrated in FIG. 2, the switched-capacitor voltage converter according to the first aspect of the present disclosure includes: a controller, a first transistor Q1, and at least one conversion assembly.

A first terminal of the first transistor Q1 is electrically connected to the at least one conversion assembly, a second terminal of the first transistor Q1 is grounded, and a control terminal of the first transistor Q1 is electrically connected to the controller.

The switched-capacitor voltage converter has a first terminal A1 and a second terminal A1. The at least one conversion assembly is electrically connected between the first terminal A1 and the second terminal A2 of the switched-capacitor voltage converter. Each of the at least one conversion assembly includes a capacitor Cn and a plurality of transistors. Each of the at least one conversion assembly includes a first branch and a second branch. The first branch and the second branch share the capacitor Cn.

In a case where the switched-capacitor voltage converter operates in a boost mode: in a first stage, the first branch is in a charging state, the at least one conversion assembly is cascaded and is grounded via the first transistor Q1, the second branch is in a disconnected state, an input voltage is present at the first terminal A1 of the switched-capacitor voltage converter, and no output voltage is present at the second terminal A2 of the switched-capacitor voltage converter; and in a second stage, the first branch is in a disconnected state, the second branch is in a discharging state, an input voltage is present at the first terminal A1 of the switched-capacitor voltage converter, and an output voltage is present at the second terminal A2 of the switched-capacitor voltage converter.

In a case where the switched-capacitor voltage converter operates in a buck mode: in a third stage, the second branch is in a charging state, the first branch is in a disconnected state, an input voltage is present at the second terminal A2 of the switched-capacitor voltage converter, and an output voltage is present at the first terminal A1 of the switched-capacitor voltage converter; and in a fourth stage, the first branch is in a discharging state, the at least one conversion assembly is cascaded and is grounded via the first transistor Q1, the second branch is in a disconnected state, no input voltage is present at the second terminal A2 of the switched-capacitor voltage converter, and an output voltage is present at the first terminal A1 of the switched-capacitor voltage converter.

The switched-capacitor voltage converter according to the first aspect of the present disclosure includes a first branch and a second branch, wherein the first branch and the second branch share the capacitor Cn. The switched-capacitor voltage converter according to the first aspect of the present disclosure converts the magnitude of the input voltage by controlling the capacitor Cn, the first branch, and the second branch to be in different states in different stages.

Since the switched-capacitor voltage converter according to the present disclosure converts the magnitude of the input voltage based on the capacitor Cn, the switched-capacitor voltage converter allows the instantaneous current to be zero, such that a plurality of transistors in the switched-capacitor voltage converter achieves soft switching, and thus the switching loss is significantly reduced. Moreover, the capacitor Cn according to the present disclosure is not subject to conduction loss, such that the power loss of the switched-capacitor voltage converter is further reduced. In addition, the capacitor Cn per unit volume supports a large peak current, such that the power density of the switched-capacitor voltage converter is effectively increased.

The switched-capacitor voltage converter illustrated in FIG. 2 includes: a controller, at least one conversion assembly, and a first transistor Q1. The controller is configured to control the at least one conversion assembly and the first transistor Q1 to perform a boost or buck conversion on an input voltage. A first terminal of the first transistor Q1 is a drain thereof, a second terminal of the first transistor Q1 is a source thereof, and a control terminal of the first transistor Q1 is a gate thereof. The first transistor Q1 is configured to form a charging/discharging loop for a capacitor in a first branch. For a cascaded structure of the at least one conversion assembly, the first branch of each of the at least one conversion assembly is cascaded and then forms a loop via the first transistor Q1.

Each of the at least one conversion assembly includes a capacitor Cn and a plurality of transistors. A last capacitor Cn in the first branch of the at least one conversion assembly is electrically connected to the first terminal of the first transistor Q1.

In the switched-capacitor voltage converter according to the present disclosure, the at least one conversion assembly includes a first branch and a second branch, wherein the first branch and the second branch share the capacitor Cn. A terminal of the first branch is electrically connected to a first terminal A1 of the switched-capacitor voltage converter, and another terminal of the first branch is electrically connected to the first terminal of the first transistor Q1. A terminal of the second branch is electrically connected to the first terminal A1 of the switched-capacitor voltage converter, and another terminal of the second branch is electrically connected to a second terminal A2 of the switched-capacitor voltage converter.

In a case where the switched-capacitor voltage converter operates in a boost mode, the first terminal A1 of the switched-capacitor voltage converter serves as an input terminal for receiving a supply voltage, and the second terminal A2 of the switched-capacitor voltage converter serves as an output terminal for outputting the boosted voltage.

In addition, in a case where the switched-capacitor voltage converter operates in a boost mode or a buck mode, the switched-capacitor voltage converter operates in different stages at different times.

In the boost mode, the switched-capacitor voltage converter alternately operates in a first stage or a second stage. There is no requirement for the sequence of the first stage and the second stage. That is, the switched-capacitor voltage converter may first operate in the second stage and then in the first stage, or may first operate in the first stage and then in the second stage.

Similarly, in the buck mode, the switched-capacitor voltage converter alternately operates in a third stage and a fourth stage. There is no requirement for the sequence of the third stage and the fourth stage. That is, the switched-capacitor voltage converter may first operate in the fourth stage and then in the third stage, or may first operate in the third stage and then in the fourth stage.

The first stage is a charging stage for the boost mode of the switched-capacitor voltage converter. In the first stage, in the switched-capacitor voltage converter, the transistors in the first branch are all turned on, and the transistors in the second branch are all turned off. The capacitor Cn in the conversion assembly is electrically connected to the first terminal A1 of the switched-capacitor voltage converter via the transistors in the first branch, such that the first branch is in a charging state. The second terminal A2 of the switched-capacitor voltage converter is electrically connected to the transistors in the second branch. Therefore, in the first stage, an input voltage is present at the first terminal A1 of the switched-capacitor voltage converter, and no output voltage is present at the second terminal A2 of the switched-capacitor voltage converter.

The second stage is a discharging stage for the boost mode of the switched-capacitor voltage converter. In the second stage, in the switched-capacitor voltage converter, the transistors in the second branch are all turned on, and the transistors in the first branch are all turned off. The capacitor Cn in the conversion assembly is electrically connected to the second terminal A2 of the switched-capacitor voltage converter via the transistors in the second branch, such that the second branch is in a discharging state. The first terminal A1 of the switched-capacitor voltage converter is electrically connected to the transistors in the second branch. Therefore, in the second stage, an input voltage is present at the first terminal A1 of the switched-capacitor voltage converter, and an output voltage is present at the second terminal A2 of the switched-capacitor voltage converter.

In the buck mode, the first terminal A1 of the switched-capacitor voltage converter serves as an output terminal for outputting the bucked voltage, and the second terminal A2 of the switched-capacitor voltage converter serves as an input terminal for receiving the supply voltage.

The third stage is a charging stage for the buck mode of the switched-capacitor voltage converter. In the third stage, in the switched-capacitor voltage converter, the transistors in the second branch are all turned on, and the transistors in the first branch are all turned off. The capacitor Cn in the conversion assembly is electrically connected to the second terminal A2 of the switched-capacitor voltage converter via the transistors in the second branch, such that the second branch is in a charging state. The first terminal A1 of the switched-capacitor voltage converter is electrically connected to the transistors in the second branch. Therefore, in the third stage, an output voltage is present at the first terminal A1 of the switched-capacitor voltage converter, and an input voltage is present at the second terminal A2 of the switched-capacitor voltage converter.

The fourth stage is a discharging stage for the buck mode of the switched-capacitor voltage converter. In the fourth stage, in the switched-capacitor voltage converter, the transistors in the first branch are all turned on, and the transistors in the second branch are all turned off. The capacitor Cn in the conversion assembly is electrically connected to the first terminal A1 of the switched-capacitor voltage converter via the transistors in the first branch, such that the first branch is in a discharging state. The second terminal A2 of the switched-capacitor voltage converter is electrically connected to the transistors in the second branch. Therefore, in the fourth stage, no input voltage is present at the second terminal A2 of the switched-capacitor voltage converter, and an output voltage is present at the first terminal A1 of the switched-capacitor voltage converter.

The switched-capacitor voltage converter may boost the input voltage in one time period and buck the input voltage in another time period. Different operations may be performed by the switched-capacitor voltage converter at different times. In a case where the switched-capacitor voltage converter is to perform a boost operation, both the first stage and the second stage need to be performed. In a case where the switched-capacitor voltage converter is to perform a buck operation, both the third stage and the fourth stage need to be performed.

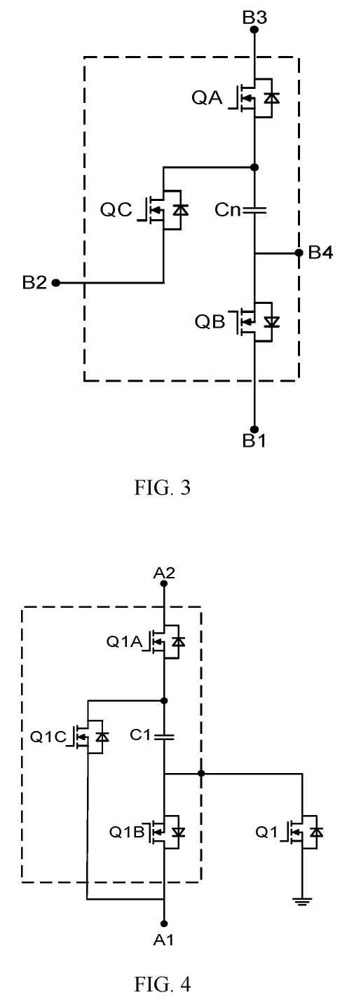

FIG. 3 is a circuit diagram of a conversion assembly in a switched-capacitor voltage converter according to some embodiments of the present disclosure. As illustrated in FIG. 3, in some embodiments of the switched-capacitor voltage converter according to the first aspect, a conversion assembly 2 includes: a second transistor QC, a third transistor QA, a fourth transistor QB, and a capacitor Cn.

A first terminal of the third transistor QA is electrically connected to the second terminal A2 of the switched-capacitor voltage converter, a second terminal of the third transistor QA is electrically connected to a first terminal of the capacitor Cn, and a control terminal of the third transistor QA is electrically connected to the controller.

A first terminal of the fourth transistor QB is electrically connected to the first terminal A1 of the switched-capacitor voltage converter, a second terminal of the fourth transistor QB is electrically connected to a second terminal of the capacitor Cn, and a control terminal of the fourth transistor QB is electrically connected to the controller.

A first terminal of the second transistor QC is electrically connected between the second terminal of the third transistor QA and the first terminal of the capacitor Cn, a second terminal of the second transistor QC is electrically connected to the first terminal A1 of the switched-capacitor voltage converter or to an adjacent conversion assembly, and a control terminal of the second transistor QC is electrically connected to the controller.

The conversion assembly 2 includes: a first terminal B1, a second terminal B2, a third terminal B3, and a fourth terminal B4. The first terminal B1 of the conversion assembly 2 is electrically connected to the first terminal A1 of the switched-capacitor voltage converter, wherein the first terminal B1 is the first terminal of the fourth transistor QB. The second terminal B2 of the conversion assembly 2 is electrically connected to the first terminal A1 of the switched-capacitor voltage converter or to an adjacent conversion assembly, wherein the second terminal B2 of the conversion assembly 2 is the second terminal of the second transistor QC. The third terminal B3 of the conversion assembly 2 is electrically connected to the second terminal A2 of the switched-capacitor voltage converter, wherein the third terminal B3 of the conversion assembly 2 is the first terminal of the third transistor QA. The fourth terminal B4 of the conversion assembly 2 is electrically connected to the first terminal of the first transistor Q1 or to another adjacent conversion assembly, wherein the fourth terminal B4 of the conversion assembly 2 is located between the second terminal of the fourth transistor QB and the second terminal of the capacitor Cn.

The first terminal of the second transistor QC is a drain thereof, the second terminal of the second transistor QC is a source thereof, and the control terminal of the second transistor QC is a gate thereof. The first terminal of the third transistor QA is a drain thereof, the second terminal of the third transistor QA is a source thereof, and the control terminal of the third transistor QA is a gate thereof. The first terminal of the fourth transistor QB is a drain thereof, the second terminal of the fourth transistor QB is a source thereof, and the control terminal of the fourth transistor QB is a gate thereof. The first terminal of the capacitor Cn is a positive terminal thereof, and the second terminal of the capacitor Cn is a negative terminal thereof.

Referring to FIG. 4, FIG. 4 is a circuit diagram of a switched-capacitor voltage converter where the number of conversion assemblies is one according to some embodiments of the present disclosure. In some embodiments of the switched-capacitor voltage converter according to the first aspect of the present disclosure, in a case where the number of the at least one conversion assembly is one, the second terminal of the second transistor QC in the conversion assembly is electrically connected to the first terminal A1 of the switched-capacitor voltage converter.

The first terminal of the first transistor Q1 is electrically connected between the second terminal of the capacitor Cn and the second terminal of the fourth transistor QB in the one conversion assembly.

In the switched-capacitor voltage converter according to the embodiment of the present disclosure, the second transistor QC is configured to be connected to a plurality of conversion assemblies or to the first terminal A1 of the switched-capacitor voltage converter to form the first branch. In a case where the number of conversion assemblies in the switched-capacitor voltage converter is one, the first terminal of the second transistor QC in the conversion assembly is electrically connected to the first terminal A1 of the switched-capacitor voltage converter. Electrically connecting the first terminal of the second transistor QC to the first terminal A1 of the switched-capacitor voltage converter allows the capacitor Cn to be charged based on the input voltage at the first terminal of the switched-capacitor voltage converter in a case where the switched-capacitor voltage converter is in the first stage, or allows the capacitor Cn to supply a voltage to the output terminal of the switched-capacitor voltage converter in a case where the switched-capacitor voltage converter is in the fourth stage. The drain of the first transistor Q1 is electrically connected to the negative terminal of the capacitor Cn in the conversion assembly.

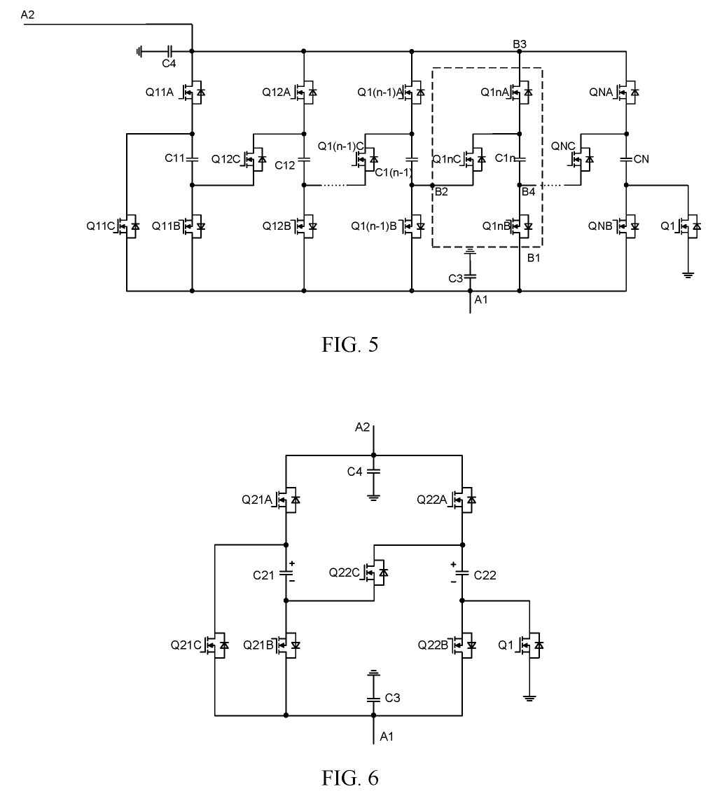

Referring to FIG. 5, FIG. 5 is a circuit diagram of a switched-capacitor voltage converter where the number of conversion assemblies is more than one according to some embodiments of the present disclosure. In some embodiments of the switched-capacitor voltage converter according to the first aspect of the present disclosure, in a case where the number of the at least one conversion assembly is greater than one, a plurality of conversion assemblies are connected in series.

A second terminal of the second transistor QC in a first one of the plurality of conversion assemblies is electrically connected to the first terminal A1 of the switched-capacitor voltage converter, and a second terminal of the second transistor QC in each of the remaining ones of the plurality of conversion assemblies is electrically connected to the first terminal of the capacitor Cn in an adjacent conversion assembly.

The second terminal of the capacitor Cn in a last one of the plurality of conversion assemblies is electrically connected to the first terminal of the first transistor Q1.

The number of conversion assemblies in the switched-capacitor voltage converter according to the present disclosure may be determined based on specific voltage conversion requirements. In a case where the switched-capacitor voltage converter includes a plurality of conversion assemblies, the plurality of conversion assemblies are connected in series. The third terminal B3 of each of the plurality of conversion assemblies is electrically connected to the second terminal A2 of the switched-capacitor voltage converter, and the first terminal B1 of each of the plurality of conversion assemblies is electrically connected to the first terminal A1 of the switched-capacitor voltage converter.

In a connection structure of the plurality of conversion assemblies, the first terminal of the second transistor QC in the first one of the conversion assemblies is electrically connected to the first terminal A1 of the switched-capacitor voltage converter. In the connection structure of the plurality of conversion assemblies, the first terminal of the second transistor QC in each of the conversion assemblies other than the first one of the plurality of conversion assemblies is electrically connected to the second terminal of the capacitor Cn of a preceding conversion assembly. The plurality of conversion assemblies correspondingly includes a plurality of second transistors QC and a plurality of capacitors Cn, and the plurality of second transistors QC and the plurality of capacitors Cn form the first branch, which outputs via the first transistor Q1. In each of the conversion assemblies, the third transistor QA, the fourth transistor QB, and the capacitor Cn form the second branch. The plurality of conversion assemblies correspondingly included a plurality of second branches.

Referring to FIG. 5, in some embodiments, in a case where the switched-capacitor voltage converter operates in the boost mode and the number of the at least one conversion assembly is N, wherein N is a positive integer, a ratio between a magnitude of an input voltage of the switched-capacitor voltage converter and a magnitude of an output voltage of the switched-capacitor voltage converter is N:(N+1).

In a case where the switched-capacitor voltage converter operates in the buck mode and the number of the at least one conversion assembly is N, the ratio between the magnitude of the input voltage of the switched-capacitor voltage converter and the magnitude of the output voltage of the switched-capacitor voltage converter is (N+1):N; wherein N is a positive integer.

In the switched-capacitor voltage converter, the number of conversion assemblies is determined based on a magnitude of a target voltage and the magnitude of the input voltage. In a case where the magnitude of the target voltage is N+1 times a unit, N conversion assemblies may be arranged in the switched-capacitor voltage converter. The N conversion assemblies convert the input voltage, such that the magnitude of the output voltage of the switched-capacitor voltage converter is N+1 times the unit.

Referring to FIG. 5, in a case where the switched-capacitor voltage converter includes N conversion assemblies, and the switched-capacitor voltage converter includes one first branch, N second branches, and N capacitors. The N capacitors Cn are sequentially designated as C11, C12, C13, ..., CN. In the first branch, the N capacitors Cn are connected in series to N second transistors QC. The N second transistors QC are sequentially designated as Q11C, Q12C, Q13C, ..., QNC. In a case where the first branch is in a disconnected state, the N second branches are connected in parallel, and correspondingly, the N capacitors Cn in the N second branches are connected in parallel. The N second branches include N third transistors QA and N fourth transistors QB. The N third transistors QA are sequentially designated as Q11A, Q12A, Q13A, ..., QNA. The N fourth transistors QB are sequentially designated as Q11B, Q12B, Q13B, ..., QNB. The capacitor Cn in the first branch and the second branch of the same conversion assembly is the same capacitor. Here, n is a positive integer.

Referring to FIG. 5, in a case where the number of conversion assemblies in the switched-capacitor voltage converter is N and the switched-capacitor voltage converter operates in the boost mode, in the first stage, all N series-connected capacitors Cn in the first branch are charged. The N capacitors Cn divide the input voltage. In the second stage, the capacitors Cn in the N second branches are all discharged, and voltages thereof are added to the input voltage to boost the input voltage.

Referring to FIG. 5, a voltage calculation method for the boost mode is as follows: in the first stage, the N capacitors Cn divide the input voltage of the switched-capacitor voltage converter, and a voltage across each of the N capacitors Cn is 1/N of the input voltage; and in the second stage, a voltage generated by the discharge of the N capacitors Cn is added to the input voltage, such that the ratio of the magnitude of the output voltage to the magnitude of the input voltage of the switched-capacitor voltage converter is (N+1):N.

Referring to FIG. 5, in a case where the number of conversion assemblies in the switched-capacitor voltage converter is N and the switched-capacitor voltage converter operates in the buck mode, in the third stage, the capacitors Cn in the N parallel-connected second branches are all in a charging state. The voltages across the N parallel-connected capacitors Cn are all equal. In the fourth stage, no input voltage is present at the second terminal A2 of the switched-capacitor voltage converter, and the N series-connected capacitors Cn in the first branch are all in a discharging state. The first terminal A1 of the switched-capacitor voltage converter outputs a voltage generated by the discharge of the capacitors Cn in the first branch, so as to buck the input voltage.

A voltage calculation method for the buck mode is as follows: in the third stage, a voltage across each of the N capacitors Cn is a difference between the input voltage and the output voltage of the switched-capacitor voltage converter. In the fourth stage, the magnitude of the output voltage of the switched-capacitor voltage converter is N times the magnitude of the voltage across each capacitor Cn. It may be thus calculated that the ratio of the magnitude of the output voltage to the magnitude of the input voltage of the switched-capacitor voltage converter is N:(N+1).

Referring to FIG. 5, the first branch includes at least one second transistor QC; the second branch includes at least one third transistor QA and at least one fourth transistor QB; and the first branch and the second branch share the capacitor Cn.

Referring to FIG. 6, FIG. 6 is a circuit diagram of a switched-capacitor voltage converter where the number of conversion assemblies is two according to some embodiments of the present disclosure. In some embodiments of the switched-capacitor voltage converter according to the first aspect of the present disclosure: in the first stage, the first transistor Q1 and the second transistors QC are turned on, the third transistors QA and the fourth transistors QB are turned off, and the capacitors Cn are in a charging state; and in the second stage, the first transistor Q1 and the second transistors QC are turned off, the third transistors QA and the fourth transistors QB are turned on, and the capacitors Cn are in a discharging state.

Referring to FIG. 6, in the third stage, the first transistor Q1 and the second transistors QC are turned off, the third transistors QA and the fourth transistors QB are turned on, and the capacitors Cn are in a charging state; and in the fourth stage, the first transistor Q1 and the second transistors QC are turned on, the third transistors QA and the fourth transistors QB are turned off, and the capacitors Cn are in a discharging state.

In the switched-capacitor voltage converter according to the present disclosure, the controller controls the first transistor Q1, the second transistors QC, the third transistors QA, and the fourth transistors QB to be in a turned-on or turned-off state.

Referring to FIGS. 6 to 8, FIG. 7 is a circuit diagram of the switched-capacitor voltage converter illustrated in FIG. 6 operating in the first stage. FIG. 8 is a circuit diagram of the switched-capacitor voltage converter illustrated in FIG. 6 operating in the second stage. FIG. 6 provides an example where the number of conversion assemblies in the switched-capacitor voltage converter is two. The number of conversion assemblies is not limited to the aforementioned quantity and may be determined based on specific requirements.

In a connection structure of the two conversion assemblies illustrated in FIG. 6, the second transistor in the first conversion assembly is a transistor Q21C; the second transistor in the second conversion assembly is a transistor Q22C; the third transistor in the first conversion assembly is a transistor Q21A; the third transistor in the second conversion assembly is a transistor Q22A; the fourth transistor in the first conversion assembly is a transistor Q21B; the fourth transistor in the second conversion assembly is a transistor Q22B; the capacitor in the first conversion assembly is a capacitor C21; and the capacitor in the second conversion assembly is a capacitor C22.

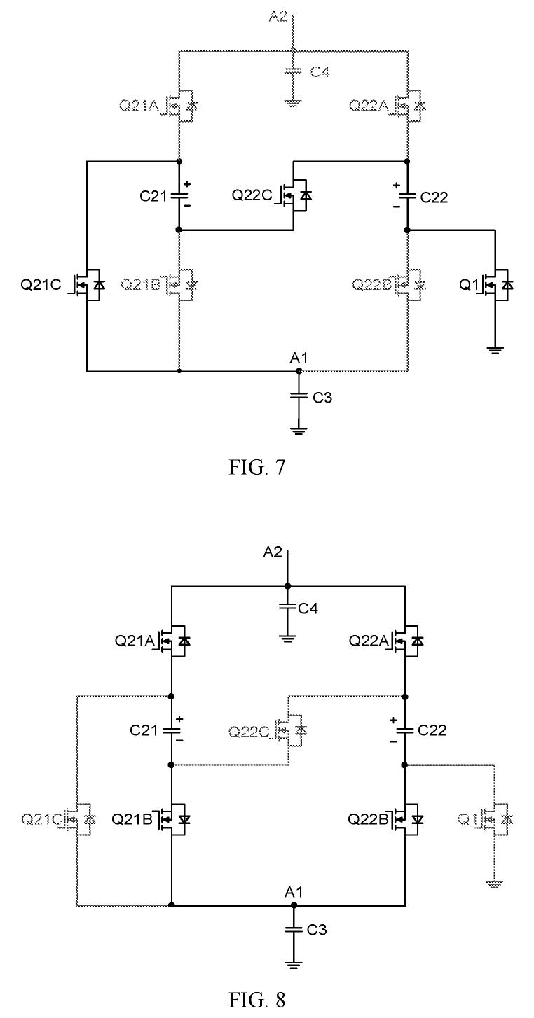

Referring to FIGS. 6 and 7, in a case where the switched-capacitor voltage converter is in the first stage of the boost mode, the switched-capacitor voltage converter operates in a first phase. The controller controls the first transistor Q1 and the second transistors QC in both conversion assemblies to be all turned on, and controls the third transistors QA and the fourth transistors QB in both conversion assemblies to be all turned off. This forms the conduction circuit as illustrated in FIG. 7.

Referring to FIGS. 6 and 7, the first terminal A1 of the switched-capacitor voltage converter supplies an input voltage to the capacitors Cn via the second transistors QC, and since the positive terminal of each capacitor Cn is electrically connected to a respective second transistor QC, the capacitors Cn start to charge. The second terminal A2 of the switched-capacitor voltage converter is configured to output a voltage, but since the second terminal A2 is electrically connected to the third transistors QA, no output voltage is output from the switched-capacitor voltage converter.

Referring to FIGS. 6 and 8, in a case where the switched-capacitor voltage converter is in the second stage of the boost mode, the switched-capacitor voltage converter operates in a second phase. The controller controls the first transistor Q1 and the second transistors QC in both conversion assemblies to be all turned off, and controls the third transistors QA and the fourth transistors QB in both conversion assemblies to be all turned on. This forms the conduction circuit as illustrated in FIG. 8.

Referring to FIGS. 6 and 8, the first terminal A1 of the switched-capacitor voltage converter outputs the voltage to the capacitors Cn via the fourth transistors QB, and the second terminal A2 of the switched-capacitor voltage converter receives the voltage from the capacitors Cn via the third transistors QA. In the first stage, the capacitors Cn are charged. In the second stage, the capacitors Cn start to discharge. The voltage generated by the discharging capacitors Cn is in the same direction as the input voltage of the switched-capacitor voltage converter. The voltage from the capacitors Cn is added to the input voltage, such that the magnitude of the voltage at the output terminal of the switched-capacitor voltage converter is greater than the magnitude of the input voltage.

In a case where the switched-capacitor voltage converter is in the third stage of the buck mode, the switched-capacitor voltage converter operates in a third phase. The controller controls the first transistor Q1 and the second transistors QC to be all turned off, and controls the third transistors QA and the fourth transistors QB to be all tuned on. The first terminal A1 of the switched-capacitor voltage converter outputs a voltage, while the second terminal A2 inputs a voltage. Since the positive terminal of each of the capacitors Cn is connected to the second terminal A2 via a respective third transistor QA, and the negative terminal of each of the capacitors Cn is connected to the first terminal A1 via a respective fourth transistor QB, the capacitors Cn start to charge. In this case, the switched-capacitor voltage converter has an output voltage.

In a case where the switched-capacitor voltage converter is in the fourth stage of the buck mode, the switched-capacitor voltage converter operates in a fourth phase. The controller controls the first transistor Q1 and the second transistors QC to be all turned on, and controls the third transistors QA and the fourth transistors QB to be all turned off. Since the second terminal A2 is configured to input a voltage and is electrically connected to the third transistors QA, no input voltage is supplied to the switched-capacitor voltage converter at this time. The positive terminal of each of the capacitors Cn is electrically connected to a respective second transistor QC, and the capacitors Cn start to discharge. The voltage generated by the discharging capacitors Cn is output to the first terminal A1 of the switched-capacitor voltage converter via the second transistors QC, such that an output voltage is supplied from the switched-capacitor voltage converter.

Since the input voltage is the sum of the output voltage and the capacitor voltage, the input voltage is reduced when the capacitors charge in the third stage. In the fourth stage, the capacitors discharge while there is no input voltage. Consequently, the magnitude of the voltage at the output terminal is less than the magnitude of the input voltage.

In a case where the switched-capacitor voltage converter boosts the input voltage, the first stage and the second stage are different stages within the same cycle and occur alternately within one cycle. The first phase and the second phase together constitute a boost process.

In a case where the switched-capacitor voltage converter bucks the input voltage, the third stage and the fourth stage are different stages within the same cycle and occur alternately within one cycle. The third stage and the fourth stage together constitute a buck process, and initially, the controller controls the switched-capacitor voltage converter to be in the third stage.

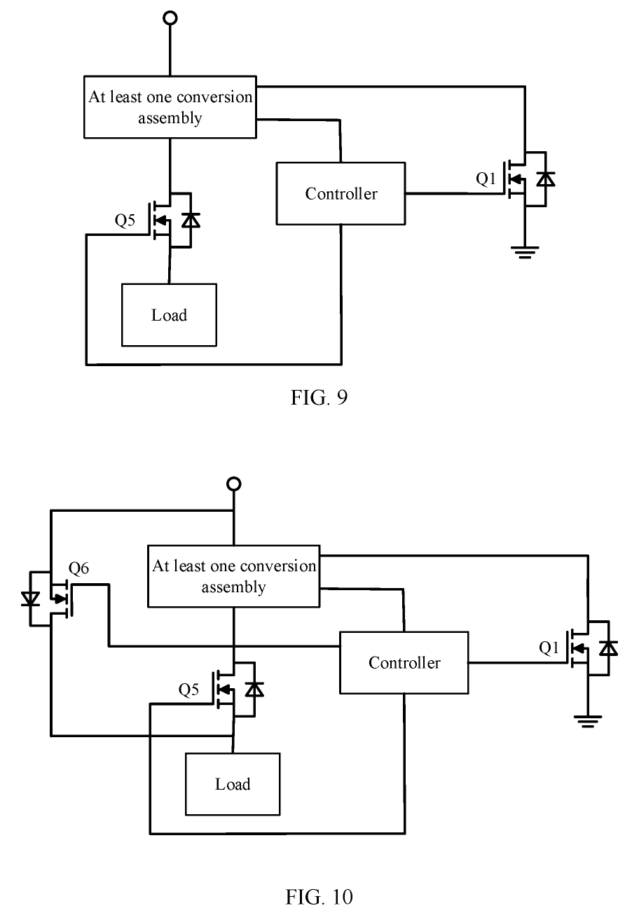

Referring to FIG. 9, FIG. 9 is a schematic structural diagram of another switched-capacitor voltage converter electrically connected to a load according to some embodiments of the present disclosure. In some embodiments, the switched-capacitor voltage converter further includes a fifth transistor Q5.

A first terminal of the fifth transistor Q5 is electrically connected to the first terminal A1 or the second terminal of the switched-capacitor voltage converter, a second terminal of the fifth transistor Q5 is electrically connected to a load, and a control terminal of the fifth transistor Q5 is electrically connected to the controller.

In a case where the fifth transistor Q5 is turned on, the switched-capacitor voltage converter supplies a voltage to the load.

In a case where the fifth transistor Q5 is turned off, the switched-capacitor voltage converter does not supply a voltage to the load.

In some embodiments, the switched-capacitor voltage converter, when it is necessary to isolate the switched-capacitor voltage converter from the load, the controller is configured to control the fifth transistor Q5 to be turned off, so to disconnect from the output terminal of the switched-capacitor voltage converter from the load.

A source of the fifth transistor Q5 is electrically connected to the load, a drain of the fifth transistor Q5 is electrically connected to the output terminal of the switched-capacitor voltage converter, and a gate of the fifth transistor Q5 is electrically connected to the controller.

Referring to FIG. 10, FIG. 10 is a schematic structural diagram of yet another switched-capacitor voltage converter electrically connected to a load according to some embodiments of the present disclosure. In some embodiments, the switched-capacitor voltage converter further includes a sixth transistor Q6.

A first terminal of the sixth transistor Q6 is electrically connected to the first terminal A1 of the switched-capacitor voltage converter, a second terminal of the sixth transistor Q6 is electrically connected to the load, and a control terminal of the sixth transistor Q6 is electrically connected to the controller.

In response to a first instruction from the controller, the fifth transistor Q5 is turned off, the sixth transistor Q6 is turned on, and the switched-capacitor voltage converter does not supply a voltage to the load.

In response to a second instruction from the controller, the fifth transistor Q5 is turned on, the sixth transistor Q6 is turned off, and the switched-capacitor voltage converter supplies a voltage to the load.

In some embodiments, in a case where an output voltage from a power source is within an acceptable voltage of the load, the sixth transistor Q6 is turned on and the fifth transistor Q5 is turned off, such that the supply voltage is directly connected to the load via the sixth transistor Q6.

A source of the sixth transistor Q6 is electrically connected to the input terminal of the switched-capacitor voltage converter (which may be the first terminal A1), a drain of the sixth transistor Q6 is electrically connected to the load, and a gate of the sixth transistor Q6 is electrically connected to the controller.

The controller determines whether to send the first or second instruction based on a judgment of a magnitude of the output voltage from the power source.

In a case where the magnitude of the output voltage from the power source is within the acceptable voltage range of the load, the controller generates the first instruction. In response to the first instruction, the fifth transistor Q5 is turned off and the sixth transistor Q6 is turned on. In this case, the output voltage from the power source is connected to the load via the sixth transistor Q6.

In a case where the magnitude of the output voltage from the power source is not within the acceptable voltage range of the load, the controller generates the second instruction. In response to the second instruction, the fifth transistor Q5 is turned on and the sixth transistor Q6 is turned off. In this case, the switched-capacitor voltage converter receives the output voltage from the power source, performs a voltage conversion on the received voltage, and supplies a converted voltage to the load via the fifth transistor Q5.

Furthermore, the above description only illustrates the case where the fifth transistor Q5 and the sixth transistor Q6 are arranged within the switched-capacitor voltage converter. In some other embodiments, the fifth transistor Q5 and/or the sixth transistor Q6 may be arranged outside the switched-capacitor voltage converter.

In a second aspect, some embodiments of the present disclosure provide a chip. The chip includes the switched-capacitor voltage converter as described above.

In a third aspect, some embodiments of the present disclosure provide an electronic device. The electronic device includes the chip as described above.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

What is claimed is:

1. A switched-capacitor voltage converter, comprising: a controller, a first transistor, and at least one conversion assembly; wherein
a first terminal of the first transistor is electrically connected to the at least one conversion assembly, a second terminal of the first transistor is grounded, and a control terminal of the first transistor is electrically connected to the controller;
the switched-capacitor voltage converter comprises a first terminal and a second terminal, wherein the at least one conversion assembly is electrically connected between the first terminal and the second terminal of the switched-capacitor voltage converter, each of the at least one conversion assembly comprises a capacitor and a plurality of transistors, and the at least one conversion assembly comprises a first branch and a second branch, wherein the first branch and the second branch share the capacitor;
in a case that the switched-capacitor voltage converter operates in a boost mode: in a first stage, the first branch is in a charging state, the at least one conversion assembly is cascaded and is grounded via the first transistor, the second branch is in a disconnected state, an input voltage is present at the first terminal of the switched-capacitor voltage converter, and no output voltage is present at the second terminal of the switched-capacitor voltage converter; and in a second stage, the first branch is in a disconnected state, the second branch is in a discharging state, an input voltage is present at the first terminal of the switched-capacitor voltage converter, and an output voltage is present at the second terminal of the switched-capacitor voltage converter; and
in a case that the switched-capacitor voltage converter operates in a buck mode: in a third stage, the second branch is in the charging state, the first branch is in a disconnected state, an input voltage is present at the second terminal of the switched-capacitor voltage converter, and an output voltage is present at the first terminal of the switched-capacitor voltage converter; and in a fourth stage, the first branch is in the discharging state, the at least one conversion assembly is cascaded and is grounded via the first transistor, the second branch is in a disconnected state, no input voltage is present at the second terminal of the switched-capacitor voltage converter, and an output voltage is present at the first terminal of the switched-capacitor voltage converter.

2. The switched-capacitor voltage converter according to claim 1, wherein each of the at least one conversion assembly comprises: a second transistor, a third transistor, a fourth transistor, and the capacitor; wherein
a first terminal of the third transistor is electrically connected to the second terminal of the switched-capacitor voltage converter, a second terminal of the third transistor is electrically connected to a first terminal of the capacitor, and a control terminal of the third transistor is electrically connected to the controller;
a first terminal of the fourth transistor is electrically connected to the first terminal of the switched-capacitor voltage converter, a second terminal of the fourth transistor is electrically connected to a second terminal of the capacitor, and a control terminal of the fourth transistor is electrically connected to the controller; and
a first terminal of the second transistor is electrically connected between the second terminal of the third transistor and the first terminal of the capacitor, a second terminal of the second transistor is electrically connected to the first terminal of the switched-capacitor voltage converter or is electrically connected to an adjacent one of the at least one conversion assembly, and a control terminal of the second transistor is electrically connected to the controller.

3. The switched-capacitor voltage converter according to claim 2, wherein in the first stage, the first transistor and the second transistor are turned on, the third transistor and the fourth transistor are turned off, and the capacitor is in the charging state; and in the second stage, the first transistor and the second transistor are turned off, the third transistor and the fourth transistor are turned on, and the capacitor is in the discharging state; and
in the third stage, the first transistor and the second transistor are turned off, the third transistor and the fourth transistor are turned on, and the capacitor is in the charging state; and in the fourth stage, the first transistor and the second transistor are turned on, the third transistor and the fourth transistor are turned off, and the capacitor is in the discharging state.

4. The switched-capacitor voltage converter according to claim 2, wherein in a case that a number of the at least one conversion assembly is one: in the one conversion assembly, the second terminal of the second transistor is electrically connected to the first terminal of the switched-capacitor voltage converter; and
the first terminal of the first transistor is electrically connected between the second terminal of the capacitor and the second terminal of the fourth transistor in the one conversion assembly.

5. The switched-capacitor voltage converter according to claim 2, wherein in a case that a number of the at least one conversion assembly is greater than one, the plurality of conversion assemblies are connected in series; wherein
a second terminal of the second transistor in a first one of the plurality of conversion assemblies is electrically connected to the first terminal of the switched-capacitor voltage converter, and a second terminal of the second transistor in each of remaining ones of the plurality of conversion assemblies is electrically connected to a first terminal of the capacitor in an adjacent conversion assembly; and
a second terminal of the capacitor in a last one of the plurality of conversion assemblies is electrically connected to the first terminal of the first transistor.

6. The switched-capacitor voltage converter according to claim 1, wherein in a case that the switched-capacitor voltage converter operates in the boost mode and a number of the at least one conversion assembly is N, wherein N is a positive integer, a ratio of a magnitude of an input voltage of the switched-capacitor voltage converter to a magnitude of an output voltage of the switched-capacitor voltage converter is N:(N+1); or
in a case that the switched-capacitor voltage converter operates in the buck mode and a number of the at least one conversion assembly is N, wherein N is a positive integer, a ratio between a magnitude of an input voltage of the switched-capacitor voltage converter and a magnitude of an output voltage of the switched-capacitor voltage converter is (N+1):N.

7. The switched-capacitor voltage converter according to claim 1, further comprising: a fifth transistor; wherein
a first terminal of the fifth transistor is electrically connected to the first terminal or the second terminal of the switched-capacitor voltage converter, a second terminal of the fifth transistor is electrically connected to a load, and a control terminal of the fifth transistor is electrically connected to the controller;
the switched-capacitor voltage converter is configured to supply a voltage to the load in a case that the fifth transistor is turned on; or
the switched-capacitor voltage converter is configured to not supply a voltage to the load in a case that the fifth transistor is turned off.

8. The switched-capacitor voltage converter according to claim 7, further comprising: a sixth transistor; wherein
a first terminal of the sixth transistor is electrically connected to the first terminal of the switched-capacitor voltage converter, a second terminal of the sixth transistor is electrically connected to the load, and a control terminal of the sixth transistor is electrically connected to the controller;
in response to a first instruction from the controller, the fifth transistor is turned off, the sixth transistor is turned on, and the switched-capacitor voltage converter does not supply the voltage to the load; or
in response to a second instruction from the controller, the fifth transistor is turned on, the sixth transistor is turned off, and the switched-capacitor voltage converter supplies the voltage to the load.

9. A chip, comprising: a switched-capacitor voltage converter, wherein the switched-capacitor voltage converter comprises: a controller, a first transistor, and at least one conversion assembly; wherein
a first terminal of the first transistor is electrically connected to the at least one conversion assembly, a second terminal of the first transistor is grounded, and a control terminal of the first transistor is electrically connected to the controller;
the switched-capacitor voltage converter comprises a first terminal and a second terminal, wherein the at least one conversion assembly is electrically connected between the first terminal and the second terminal of the switched-capacitor voltage converter, each of the at least one conversion assembly comprises a capacitor and a plurality of transistors, and the at least one conversion assembly comprises a first branch and a second branch, wherein the first branch and the second branch share the capacitor;
in a case that the switched-capacitor voltage converter operates in a boost mode: in a first stage, the first branch is in a charging state, the at least one conversion assembly is cascaded and is grounded via the first transistor, the second branch is in a disconnected state, an input voltage is present at the first terminal of the switched-capacitor voltage converter, and no output voltage is present at the second terminal of the switched-capacitor voltage converter; and in a second stage, the first branch is in a disconnected state, the second branch is in a discharging state, an input voltage is present at the first terminal of the switched-capacitor voltage converter, and an output voltage is present at the second terminal of the switched-capacitor voltage converter; and
in a case that the switched-capacitor voltage converter operates in a buck mode: in a third stage, the second branch is in the charging state, the first branch is in a disconnected state, an input voltage is present at the second terminal of the switched-capacitor voltage converter, and an output voltage is present at the first terminal of the switched-capacitor voltage converter; and in a fourth stage, the first branch is in the discharging state, the at least one conversion assembly is cascaded and is grounded via the first transistor, the second branch is in a disconnected state, no input voltage is present at the second terminal of the switched-capacitor voltage converter, and an output voltage is present at the first terminal of the switched-capacitor voltage converter.

10. The chip according to claim 9, wherein each of the at least one conversion assembly comprises: a second transistor, a third transistor, a fourth transistor, and the capacitor; wherein
a first terminal of the third transistor is electrically connected to the second terminal of the switched-capacitor voltage converter, a second terminal of the third transistor is electrically connected to a first terminal of the capacitor, and a control terminal of the third transistor is electrically connected to the controller;
a first terminal of the fourth transistor is electrically connected to the first terminal of the switched-capacitor voltage converter, a second terminal of the fourth transistor is electrically connected to a second terminal of the capacitor, and a control terminal of the fourth transistor is electrically connected to the controller; and
a first terminal of the second transistor is electrically connected between the second terminal of the third transistor and the first terminal of the capacitor, a second terminal of the second transistor is electrically connected to the first terminal of the switched-capacitor voltage converter or is electrically connected to an adjacent one of the at least one conversion assembly, and a control terminal of the second transistor is electrically connected to the controller.

11. The chip according to claim 10, wherein in the first stage, the first transistor and the second transistor are turned on, the third transistor and the fourth transistor are turned off, and the capacitor is in the charging state; and in the second stage, the first transistor and the second transistor are turned off, the third transistor and the fourth transistor are turned on, and the capacitor is in the discharging state; and
in the third stage, the first transistor and the second transistor are turned off, the third transistor and the fourth transistor are turned on, and the capacitor is in the charging state; and in the fourth stage, the first transistor and the second transistor are turned on, the third transistor and the fourth transistor are turned off, and the capacitor is in the discharging state.

12. The chip according to claim 10, wherein in a case that a number of the at least one conversion assembly is one: in the one conversion assembly, the second terminal of the second transistor is electrically connected to the first terminal of the switched-capacitor voltage converter; and
the first terminal of the first transistor is electrically connected between the second terminal of the capacitor and the second terminal of the fourth transistor in the one conversion assembly.

13. The chip according to claim 10, wherein in a case that a number of the at least one conversion assembly is greater than one, the plurality of conversion assemblies are connected in series; wherein
a second terminal of the second transistor in a first one of the plurality of conversion assemblies is electrically connected to the first terminal of the switched-capacitor voltage converter, and a second terminal of the second transistor in each of remaining ones of the plurality of conversion assemblies is electrically connected to a first terminal of the capacitor in an adjacent conversion assembly; and
a second terminal of the capacitor in a last one of the plurality of conversion assemblies is electrically connected to the first terminal of the first transistor.

14. The chip according to claim 9, wherein in a case that the switched-capacitor voltage converter operates in the boost mode and a number of the at least one conversion assembly is N, wherein N is a positive integer, a ratio of a magnitude of an input voltage of the switched-capacitor voltage converter to a magnitude of an output voltage of the switched-capacitor voltage converter is N:(N+1); or
in a case that the switched-capacitor voltage converter operates in the buck mode and a number of the at least one conversion assembly is N, wherein N is a positive integer, a ratio between a magnitude of an input voltage of the switched-capacitor voltage converter and a magnitude of an output voltage of the switched-capacitor voltage converter is (N+1):N.

15. The chip according to claim 9, wherein the switched-capacitor voltage converter further comprises: a fifth transistor; wherein
a first terminal of the fifth transistor is electrically connected to the first terminal or the second terminal of the switched-capacitor voltage converter, a second terminal of the fifth transistor is electrically connected to a load, and a control terminal of the fifth transistor is electrically connected to the controller;
the switched-capacitor voltage converter is configured to supply a voltage to the load in a case that the fifth transistor is turned on; or
the switched-capacitor voltage converter is configured to not supply a voltage to the load in a case that the fifth transistor is turned off.

16. The chip according to claim 15, wherein the switched-capacitor voltage converter further comprises: a sixth transistor; wherein
a first terminal of the sixth transistor is electrically connected to the first terminal of the switched-capacitor voltage converter, a second terminal of the sixth transistor is electrically connected to the load, and a control terminal of the sixth transistor is electrically connected to the controller;
in response to a first instruction from the controller, the fifth transistor is turned off, the sixth transistor is turned on, and the switched-capacitor voltage converter does not supply the voltage to the load; or
in response to a second instruction from the controller, the fifth transistor is turned on, the sixth transistor is turned off, and the switched-capacitor voltage converter supplies the voltage to the load.

17. An electronic device, comprising: a chip, wherein the chip comprises a switched-capacitor voltage converter, wherein the switched-capacitor voltage converter comprises: a controller, a first transistor, and at least one conversion assembly; wherein
a first terminal of the first transistor is electrically connected to the at least one conversion assembly, a second terminal of the first transistor is grounded, and a control terminal of the first transistor is electrically connected to the controller;
the switched-capacitor voltage converter comprises a first terminal and a second terminal, wherein the at least one conversion assembly is electrically connected between the first terminal and the second terminal of the switched-capacitor voltage converter, each of the at least one conversion assembly comprises a capacitor and a plurality of transistors, and the at least one conversion assembly comprises a first branch and a second branch, wherein the first branch and the second branch share the capacitor;
in a case that the switched-capacitor voltage converter operates in a boost mode: in a first stage, the first branch is in a charging state, the at least one conversion assembly is cascaded and is grounded via the first transistor, the second branch is in a disconnected state, an input voltage is present at the first terminal of the switched-capacitor voltage converter, and no output voltage is present at the second terminal of the switched-capacitor voltage converter; and in a second stage, the first branch is in a disconnected state, the second branch is in a discharging state, an input voltage is present at the first terminal of the switched-capacitor voltage converter, and an output voltage is present at the second terminal of the switched-capacitor voltage converter; and
in a case that the switched-capacitor voltage converter operates in a buck mode: in a third stage, the second branch is in the charging state, the first branch is in a disconnected state, an input voltage is present at the second terminal of the switched-capacitor voltage converter, and an output voltage is present at the first terminal of the switched-capacitor voltage converter; and in a fourth stage, the first branch is in the discharging state, the at least one conversion assembly is cascaded and is grounded via the first transistor, the second branch is in a disconnected state, no input voltage is present at the second terminal of the switched-capacitor voltage converter, and an output voltage is present at the first terminal of the switched-capacitor voltage converter.

18. The electronic device according to claim 17, wherein each of the at least one conversion assembly comprises: a second transistor, a third transistor, a fourth transistor, and the capacitor; wherein
a first terminal of the third transistor is electrically connected to the second terminal of the switched-capacitor voltage converter, a second terminal of the third transistor is electrically connected to a first terminal of the capacitor, and a control terminal of the third transistor is electrically connected to the controller;
a first terminal of the fourth transistor is electrically connected to the first terminal of the switched-capacitor voltage converter, a second terminal of the fourth transistor is electrically connected to a second terminal of the capacitor, and a control terminal of the fourth transistor is electrically connected to the controller; and
a first terminal of the second transistor is electrically connected between the second terminal of the third transistor and the first terminal of the capacitor, a second terminal of the second transistor is electrically connected to the first terminal of the switched-capacitor voltage converter or is electrically connected to an adjacent one of the at least one conversion assembly, and a control terminal of the second transistor is electrically connected to the controller.

19. The electronic device according to claim 18, wherein in the first stage, the first transistor and the second transistor are turned on, the third transistor and the fourth transistor are turned off, and the capacitor is in the charging state; and in the second stage, the first transistor and the second transistor are turned off, the third transistor and the fourth transistor are turned on, and the capacitor is in the discharging state; and
in the third stage, the first transistor and the second transistor are turned off, the third transistor and the fourth transistor are turned on, and the capacitor is in the charging state; and in the fourth stage, the first transistor and the second transistor are turned on, the third transistor and the fourth transistor are turned off, and the capacitor is in the discharging state.

20. The electronic device according to claim 18, wherein in a case that a number of the at least one conversion assembly is one: in the one conversion assembly, the second terminal of the second transistor is electrically connected to the first terminal of the switched-capacitor voltage converter; and
the first terminal of the first transistor is electrically connected between the second terminal of the capacitor and the second terminal of the fourth transistor in the one conversion assembly.
